(19) United States
(12) Patent Application Publication
(10) Pub. No.: US 2020/0179965 A1
(43) Pub. Date: Jun. 11, 2020

(54) TWO-FLUID FOG GENERATOR

(71) Applicants: Hong Kun SHIN, Miryang-si (KR); Oe Sook LEE, Busan (KR); Joon Oh SHIN, Suwon-si (KR); Joon Ha SHIN, Miryang-si (KR)

(72) Inventors: Hong Kun SHIN, Miryang-si (KR); Oe Sook LEE, Busan (KR); Joon Oh SHIN, Suwon-si (KR); Joon Ha SHIN, Miryang-si (KR)

(21) Appl. No.: 16/503,557

(22) Filed: Jul. 4, 2019

(30) Foreign Application Priority Data
Dec. 6, 2018 (KR) 10-2018-0156249

(51) Int. Cl. B05B 7/04; B05B 1/10; B01F 3/04; B05B 7/24

(52) U.S. Cl. CPC B05B 7/0433; B05B 7/2489; B01F 3/04099; B05B 1/10

(57) ABSTRACT

Disclosed is a two-fluid fog generator including: a low-pressure fog generator (10) breaking down liquid into liquid micro particles and spraying the liquid micro particles through a primary nozzle hole (16) of a nozzle body (13); and a fog generation unit (20) positioned on top of the nozzle body (13) and comprising: a conical pneumatic chamber (22) filled with compressed air; and a secondary nozzle hole (26) spraying fog, wherein the secondary nozzle hole (26) is located directly above the primary nozzle hole (16) and arranged in a concentric manner with the primary nozzle hole (16), wherein the fog includes a mixture of a compressed air and the liquid micro particles.

### CROSS REFERENCE TO RELATED APPLICATION

This application is based on and claims priority under 35 U.S.C. 119 to Korean Patent Application No. 10-2018-0156249, filed on Dec. 6, 2018, in the Korean Intellectual Property Office, the disclosures of which is herein incorporated by reference in their entireties.

### TECHNICAL FIELD

The present invention relates to a two-fluid fog generator applicable to vinyl greenhouses, cages and industrial facilities for humidification, temperature control, odor removal, dust prevention, and electrostatic prevention. More particularly, the present invention relates to an apparatus for forming two-fluid fog, thereby forming more fine micro fog using a less amount of compressed air, compared to a conventional low-pressure two-fluid fog generator. The two-fluid fog generator according to the present invention can break down a large amount of water particles into fine sizes in a given time period.

### TECHNICAL BACKGROUND

In general, a fog generator (also referred to as a fog forming apparatus) is an apparatus for generating and spraying fine liquid particles, such as fog. The apparatus can be employed for the purpose of medicinal fluid spraying or humidity and temperature control in vinyl greenhouses, in which a variety of types of vegetables and garden products are cultivated, or cages. In a conventional fog forming apparatus, an injector using a highly compressed air (hereinafter, referred to as a high-pressure compressed air injector) is used for breaking down liquid particles. However, the high-pressure compressed air injector is expensive and complicated in structure. Repair and maintenance are difficult and complicated when a failure such as clogging occurs. In particular, the conventional fog forming apparatus has a limit in breaking down a large amount of water in a given time period because a break-down process of liquid is made only once. Furthermore, in the conventional two-fluid fog generator, air is injected through a long channel extending in parallel to a direction as a channel through which liquid is provided. Such structure causes a significant loss of pressure.

Korean Patent No. 10-1525600B1, which is registered on Jun. 4, 2015 and issued to the same applicant as that of the present invention, discloses a micro fog forming apparatus, including a combination of a low-pressure fog generator for forming fog in a low pressure, a venturi nozzle. The venturi nozzle is provided with an inflow hole. A compressed air is injected into the inflow hole. A first coupling part and an injection pipe are disposed in a body in a linear form. The venturi tube includes an expansion part connected to the inflow hole by throttling and is positioned within the injection pipe. A second coupling part is positioned at a right angle to the first coupling part. A flow path communicating with the coupling pipe of the low-pressure fog generator is formed and serves as a throttling pass. Water particles, which are discontinuously supplied by the low-pressure fog generator, are broken down. The low-pressure fog generator and the venturi nozzle are coupled such that the coupling pipe is protruded from the nozzle body of the low-pressure fog generator and is inserted into the second coupling part of the venturi nozzle, forming the micro fog. According to the conventional patent, efficiency of breaking down water can be maximized while reducing the amount of water and compressed air (fluid) used.

The conventional technology discloses a technology for improving fog generation efficiency by the combination of the low-pressure fog generator and the venturi nozzle. However, it has a limit in breaking down a large amount of water at a time due to its structure. Specifically, the particles generated from the low-pressure fog generator are crumpled into thick particles while passing through a long nozzle pipe. The thick particles are injected into the venturi. In the conventional technology, as a pressure becomes low after a spraying process is done, the size of water particles increases. As a result, the particle size becomes uneven and break-down quality deteriorates.

According to the prior patent document, a coupling pipe is lengthily positioned in the nozzle body. A nozzle hole is elongated. Accordingly, water particles, which were broken down in a previous step, are re-aggregating to each other while passing through the elongated nozzle hole. As a result, the particle size sprayed out is thick.

### SUMMARY OF THE INVENTION

According to an embodiment of the present invention, a two-fluid fog generator includes: a low-pressure fog generator (10) breaking down liquid into liquid micro particles and spraying the liquid micro particles through a primary nozzle hole (16) of a nozzle body (13); and a fog generation unit (20) positioned on top of the nozzle body (13). The fog generation unit (20) comprises: a conical pneumatic chamber (22) filled with compressed air; and a secondary nozzle hole (26) spraying fog.

The secondary nozzle hole (26) is located directly above the primary nozzle hole (16) and arranged in a concentric manner with the primary nozzle hole (16), wherein the fog includes a mixture of a compressed air and the liquid micro particles.

The liquid micro particles sprayed from the primary nozzle hole (16) are provided to the secondary nozzle hole (26) via the conical pneumatic chamber (22). The liquid micro particles are secondarily broken down into fog by complex shearing force in the course of passing through the conical pneumatic chamber (22).

The complex shearing force is created by the compressed air and applied to the liquid micro particles at an 360-degree angle from a circumference of the primary nozzle hole (16). The fog is sprayed out from the primary nozzle hole (16) to the secondary nozzle hole (26).

An inlet (22a) is provided eccentrically on a side of the fog generation unit (20) and injects the compressed air into the conical pneumatic chamber (22) so that the compressed air swirls within the fog generation unit (20). The primary nozzle hole (16) extends in a first direction. The inlet (22a) extends in a second direction perpendicular to the first direction. The compressed air injected into the conical pneumatic chamber (22) is directed toward an inclined exterior part (17) of the nozzle body (13).

A tube extension part (16a) is provided at an external end of the primary nozzle hole (16) and is shaped to gradually expand toward the secondary nozzle hole (26). The liquid micro particles sprayed from the primary nozzle hole (16) are diffused and further broken down at the tube extension part (16a) by distending pressure.

In an embodiment, a circular exterior part (18) is protruded from an end of the inclined exterior part (17). A low pressure flow portion (23) is formed between the inclined exterior part (17) and an inclined interior part (27). The inclined exterior part (17) and the inclined interior part (27) face each other. A path, along which the compressed air passes, is formed narrows down at the low pressure flow portion (23). After passing through the low pressure flow portion (23), the compressed air has an accelerated flow speed and creates the complex shearing force.

### BRIEF DESCRIPTION OF DRAWINGS

FIG. 1 is a perspective view of a two-fluid fog generator according to an embodiment of the present invention.

FIG. 2 shows a front cross-sectional view of the two-fluid fog generator.

FIG. 3 shows an enlarged view of a conical pneumatic chamber of the two-fluid fog generator.

FIGS. 4(a) and 4(b) show swirl phenomenon in the conical pneumatic chamber of the two-fluid fog generator.

FIG. 5 is a cutaway perspective view showing a flow of compressed air injected into the conical pneumatic chamber of the two-fluid fog generator.

FIG. 6 shows a tube extension part of the two-fluid fog generator.

FIG. 7 shows a low pressure flow portion of the two-fluid fog generator.

### DESCRIPTION OF REFERENCE NUMERALS

10: low-pressure fog generator
11: fog main body
12: fluid inducement member
13: nozzle body
14: contact nut
16: primary nozzle hole
16a: tube extension part
17: inclined exterior part
18: circular exterior part
20: fog generation unit
22: conical pneumatic chamber
22a: inlet
23: low pressure flow portion
26: secondary nozzle hole
27: inclined interior part

### DETAILED DESCRIPTION

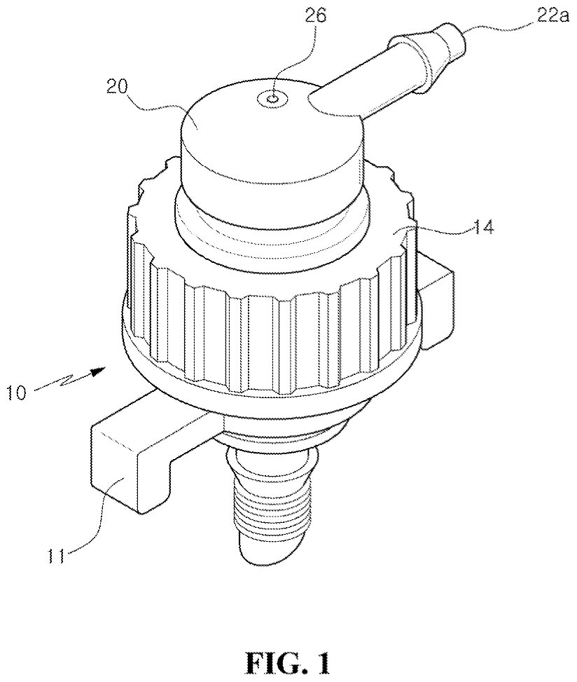

Hereinafter, embodiments of the present invention are described with reference to the accompanying drawings. An embodiment of the present invention is related to a two-fluid fog generator. The two-fluid fog generator may be applied to a cultivation structure, such as vinyl greenhouses and cages, and configured to spray micro water particles, such as fog. As shown in FIG. 1, the two-fluid fog generator includes a low-pressure fog generator (10) and a fog generation unit (20). The fog generation unit (20) is coupled to the top of the low-pressure fog generator. While passing through a conical pneumatic chamber, liquid micro particles primarily are broken down by the low-pressure fog generator. Then the liquid micro particles are secondarily broken down into more fine particles by a swirling compressed air. The liquid micro particles are supplied in a first direction. The compressed air is injected in a second direction perpendicular to the first direction. According to the present invention, a fog can be generated and sprayed in a uniform size.

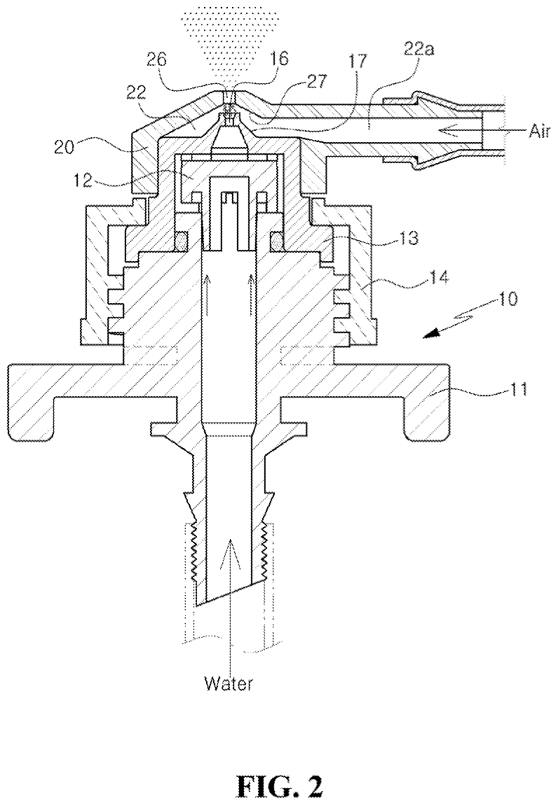

FIG. 2 shows a front cross-sectional view of a two-fluid fog generator according to an embodiment of the present invention. A low-pressure fog generator (10) primarily breaks down liquid into micro particles using a primary nozzle hole (16) of a nozzle body (13) and sprays out the micro particles. The low-pressure fog generator (10) basically includes a fog main body (11), a fluid inducement member (12) positioned over the fog main body (11), a nozzle body (13) sealing the top of the fluid inducement member (12), and a contact nut (14) screwed onto the fog main body (11) to pressurize the nozzle body (13) toward the fluid inducement member (12). Micro fog having 60˜200 μm in size is sprayed out through the primary nozzle hole (16) by guidance of the fluid inducement member (12) and the nozzle body (13).

The low-pressure fog generator (10) according to an embodiment of the present invention is similar in structure to that of the low-pressure fog generator (10) disclosed in the above-mentioned Korean Patent No. 10-1690304, which was invented by the same inventor as the inventor of the present invention in that it is designed to form a fog in a low pressure (2˜3 kg/cm²). However, it is different from that of Korean Patent No. 10-1690304 in that the length of the primary nozzle hole (16) is formed shorter. In the conventional structure, a nozzle hole is formed long. Thus, water particles are re-aggregated each other to form large size particles while passing through the long nozzle hole. This problem can be prevented in the present invention.

According to an embodiment of the present invention, the fog generation unit (20) is positioned on top of the nozzle body (13) and includes a conical pneumatic chamber (22) filled with compressed air and a secondary nozzle hole (26) located at a concentric position of the primary nozzle hole (16) of the low-pressure fog generator (10) to spray fog. The fog may be a mixture of compressed air and liquid micro particles.

The fog generation unit (20) has an open bottom and in a cap shape. The fog generation unit (20) is spaced apart from the nozzle body (13) and covers the entire surface the nozzle body (13). The nozzle body (13) includes the primary nozzle hole (16). The conical pneumatic chamber (22) is formed in a space between the fog generation unit (20) and the top of the nozzle body (13). The conical pneumatic chamber (22) is in a tapered structure upward, i.e., in a top-narrow and bottom-wide structure. Under such structure, an internal space of the conical pneumatic chamber (22) decreases toward the secondary nozzle hole (26).

The fog generation unit (20) is coupled to the nozzle body (13) by tight fitting or by a screw coupling so that it can be easily disassembled and cleaned when a clogging failure occurs.

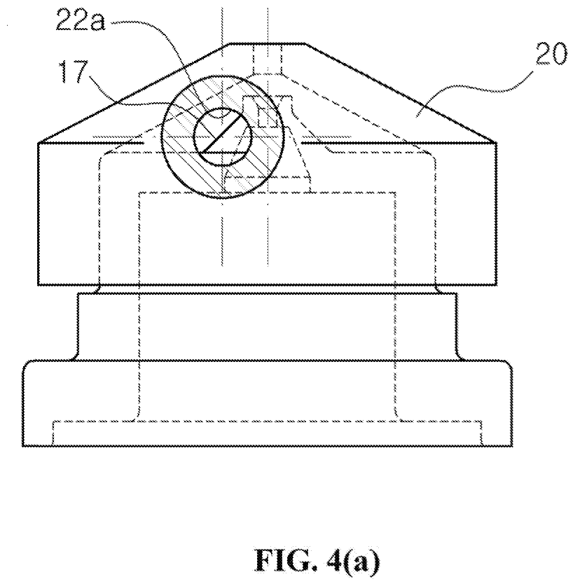

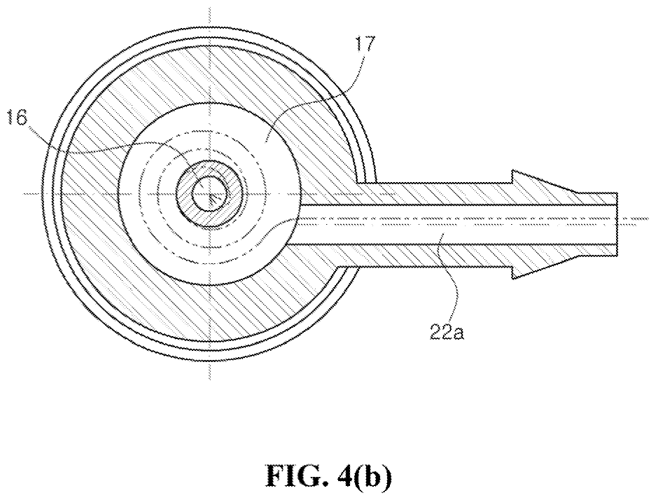

The fog generation unit (20) is positioned on top of the nozzle body (13). The primary nozzle hole (16) and the secondary nozzle hole (26) are spaced apart. A flow passage of the compressed air is formed in all directions around a circumference of the primary nozzle hole (16). Referring to FIGS. 2 and 4(b), liquid micro particles are sprayed from the primary nozzle hole (16) are moved to the secondary nozzle hole (26) via the conical pneumatic chamber (22). In the course of passing through the conical pneumatic chamber (22), the liquid micro particles are secondarily broken down into more fine particles by a pressure of the compressed air sprayed at a 360-degrees angle from the circumference of the primary nozzle hole (16). A complex shearing force is applied to the liquid micro particles, thereby uniformly breaking down the liquid micro particles into more fine particles in size of 5˜35 μm. The complex shearing force is a sum of a horizontal shearing force created by rotation of a swirling compressed air and a vertical shearing force created by the liquid micro particles sprayed toward the secondary nozzle hole (26). The primary nozzle hole (16) extends in a first direction. The swirling compressed air is supplied in a second direction perpendicular to the first direction.

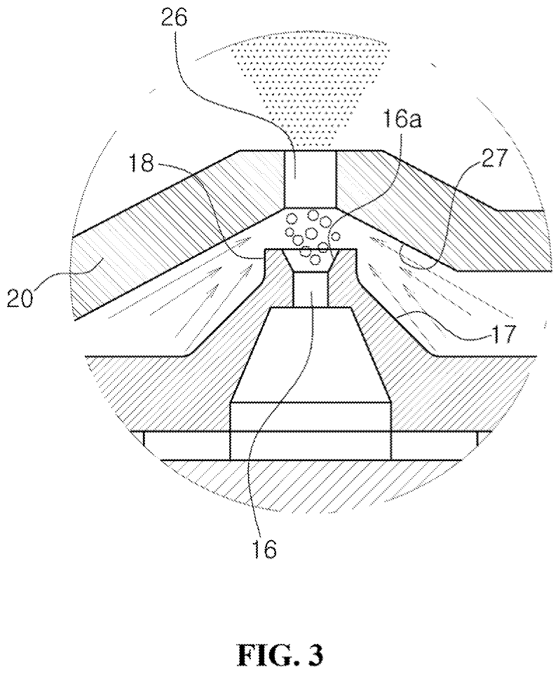

FIG. 3 shows an enlarged view of the conical pneumatic chamber (22) of the two-fluid fog generator. An inclined exterior part (17) is formed on top of the nozzle body (13) in a protruding shape. The primary nozzle hole (16) protrudes from an inclined exterior part (17). The fog generation unit (20) is connected to the secondary nozzle hole (26). A bottom of fog generation unit (20) forms an inclined interior part (27). When viewed in the cross section of FIG. 3, an angle formed by the hypotenuse of the inclined exterior part (17) with respect to the first direction is smaller than an angle formed by the hypotenuse of the inclined interior part (27) with respect to the first direction. As a result, the internal diameter of the conical pneumatic chamber (22) has a top-narrow, bottom-wide structure with volume decreasing toward the secondary nozzle hole (26).

As described above, an internal volume of the conical pneumatic chamber (22) gradually decreases toward the secondary nozzle hole (26). Under such structure, a flow speed of the compressed air is increased in the conical pneumatic chamber (22). Thus, water particles are not re-aggregated even under a low air pressure and even when the amount of compressed air supplied in is small. Accordingly, fog generation efficiency, that is, break-down efficiency, improves.

FIGS. 4(a) and 4(b) show air swirling phenomenon occurring in the conical pneumatic chamber (22) of the two-fluid fog generator according to an embodiment of the present invention. The inlet (22a) for injecting the compressed air into the conical pneumatic chamber (22) is formed on a side of the fog generation unit (20). The primary nozzle hole (16) extends in the first direction. As shown in FIG. 4(a), the compressed air is injected into the conical pneumatic chamber (22) in the second direction, which is perpendicular to the first direction. The inlet (22a) is eccentrically positioned on the fog generation unit (20) and guides the compressed air to direct toward the inclined exterior part (17) of the nozzle body (13).

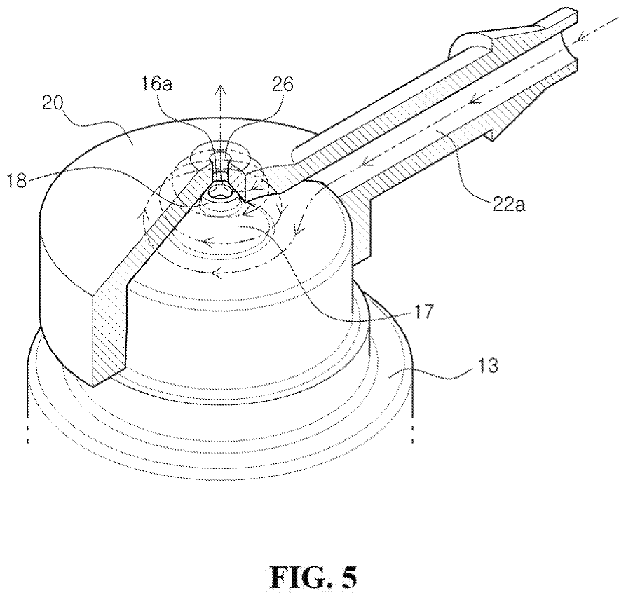

As shown in FIG. 4(b) and FIG. 5, the compressed air injected into the inlet (22a) rotates while flowing along the conical pneumatic chamber (22), thereby creating a swirl. The conical pneumatic chamber (22) is formed surrounding the circumference of the primary nozzle hole (16). As the internal volume of the conical pneumatic chamber (22) gradually decreases toward the secondary nozzle hole (26) as described above, the flowing rate of the liquid (or the liquid micro particles) is increased. Accordingly, even under a low air pressure and even with a small amount of compressed air supply, the liquid micro particles can be further broken down into more fine particles, i.e., the fog, in a uniform size.

In the process of generating fog, since the compressed air is introduced into the conical pneumatic chamber (22) located at an eccentric position, a strong whirlpool or swirl is created. Accordingly, a change in a discharge amount is reduced compared to a change in pressure, thereby bringing about an excellent pressure compensation effect.

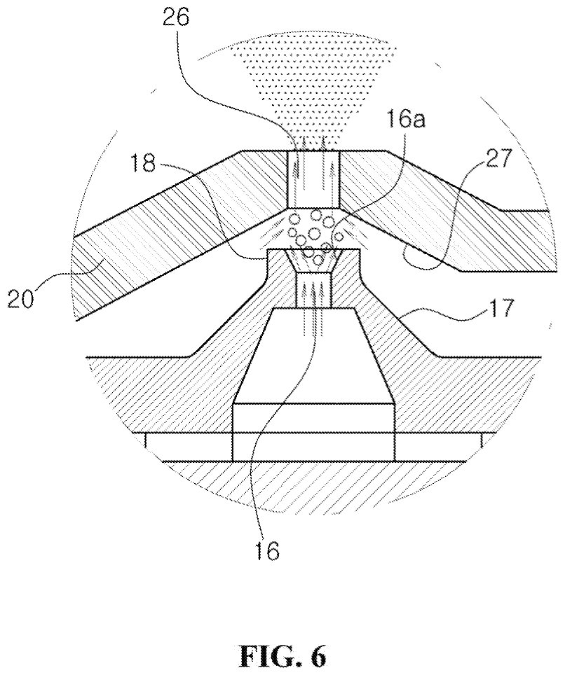

Referring to FIG. 6, the primary nozzle hole (16) is smaller in a diameter size than the secondary nozzle hole (26). A tube extension part (16a) in a horn shape (also referred to as “a reverse-tapered structure”) is formed at an external end of the primary nozzle hole (16). Here, the “horn shape” or the “reverse-tapered structure” means that the tube extension part (16a) gradually expands in a diameter as approaching toward the secondary nozzle hole (26). After passing through the primary nozzle hole (16), the liquid micro particles are subject to a distending pressure at the tube extension part (16a) and are diffused and broken down into more fine particles. In the course of passing through the conical pneumatic chamber (22), the liquid micro particles are surrounded by the compressed air (that is, in contact with the compressed air at a 360-degree angle). The compressed air creates a strong complex shearing force. Upon confrontation of the strong complex shearing force, the liquid micro particles are further broken down into more fine particles, i.e., fog, in a size of 5˜35 μm.

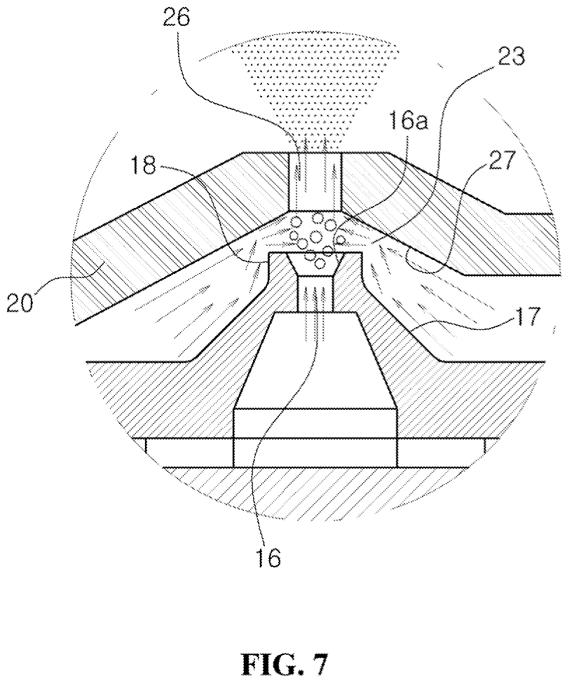

Referring to FIG. 7, a circular exterior part (18) is protruded from an end of the inclined exterior part (17). The interior and the exterior parts (17) and (27) face each other. The circular exterior part (18) protrudes from an end of the exterior parts (17). A low pressure flow portion (23) is formed between the circular exterior part (18) and the exterior part (27). A path, through which the compressed air passes, narrows down at the low pressure flow portion (23).

When the compressed air moves along the conical pneumatic chamber (22), a moving speed of the compressed air instantaneously increases at the low pressure flow portion (23). After passing through the low pressure flow portion (23), the compressed air is diffused by distending pressure and then comes in contact with the micro particles, which are sprayed from the primary nozzle hole (16), at high speed. As a result, a strong complex shearing force is applied to the micro particles. The micro particles are broken down into fine particles by the strong complex shearing force. Then, the fine particles pass through the secondary nozzle hole (26). Between the primary nozzle hole (16) and the secondary nozzle hole (26), the fine particles are surrounded at a 360-degree angle by a swirling compressed air having an angular velocity and are further broken down into more fine particles.

TABLE 1

| | | | Amount | |
|---|---|---|---|---|
| Water | Air | Amount | of water | Particle |
| pressure | pressure | of air | broken down | size |
| (bar) | (bar) | (l/minute) | (l/hour) | (μm) |
| 2 | 2 | 22 | 3 | 25~35 |
| 3 | 3 | 28.5 | 4.4 | 15~25 |

Table 1 shows experiment data obtained using a two-fluid fog generator according to an embodiment of the present invention. As shown in the Table 1, the amount of broken-down water was 3 l per minute when water was processed under the condition of 22 l of air supply per minute, 2 bar of water pressure, and 2 bar of air pressure. The size of micro particles obtained under the process condition was uniform and is between 25˜35 μm.

As shown in the Table 1, the amount of broken-down water was 4.4 l per minute when water was processed under the condition of 28.5 l of air supply per minute, 3 bar of water pressure, and 3 bar of air pressure. The size of micro particles obtained under the process condition was uniform and is more fine between 15˜25 μm.

From the experiments, it is noted that the amount of broken-down water does not linearly increase in proportion with a water pressure applied and an air pressure applied. That is, according to the present invention, a large amount of broken-down water, i.e., 3 l of fine particles per minute, in a particle size of 25˜35 μm can be generated under a relatively mild condition, i.e., under only a relatively small amount of water pressure (2 bar) and a low air pressure (2 bar).

As described above, in the two-fluid fog generator according to an embodiment of the present invention, the compressed air is supplied in the direction perpendicular to the direction in which the liquid particles are supplied. The inlet is positioned at an eccentric location on the conical pneumatic chamber to have the compressed air strongly swirled within the fog generation unit. Under such structure, a relatively large amount of fine fog in a uniform particle size can be generated using a relatively small amount of compressed air compared to a conventional apparatuses.

The present invention is advantageous in that liquid particles can be broken down into fine particles in a uniform size of 5˜35 μm. Liquid particles are primarily broken down into fine particles by the low-pressure fog generator and then secondarily broken down into more fine particles by a compressed air pressure applied from all directions, i.e., from a 360-degree angle, while passing through the conical pneumatic chamber.

The conical pneumatic chamber (22) is structured such that its internal space gradually decreases toward the secondary nozzle hole. The inclined interior part (27) of the fog generation unit (20) and the exterior parts (17) of the nozzle body (13) are configured for the conical pneumatic chamber to have such structure. The compressed air swirls between the inclined interior and exterior parts (17) (27). Under such structure, re-aggregation of water particles are prevented and fog generation can be processed using a relatively small amount of compressed air supply and under a relatively low water pressure condition. Accordingly, fog generation efficiency is improved.

Furthermore, the inlet (22a) for injecting the compressed air into the conical pneumatic chamber is positioned at an eccentric location toward the inclined exterior part. Under such structure, a strong whirlpool or swirl is generated when the compressed air is supplied. Accordingly, a pressure compensation effect entails. Furthermore, water particles are further broken down into fine particles by a complex shearing force. The complex shearing force is a sum of a shearing force applied by a swirl of the compressed air and a shearing force applied in an axial direction of the secondary nozzle hole.

It should be noted that the present invention is not limited to the embodiments described in the detailed description of the present invention. Rather, the present invention may be modified in various ways without departing from the sprits and scope of the present invention. Accordingly, the range of protection of the present invention should not be limited to the embodiments, but should be construed by the claims.

1. A two-fluid fog generator, comprising:
a low-pressure fog generator (10) breaking down liquid into liquid micro particles and spraying the liquid micro particles through a primary nozzle hole (16) of a nozzle body (13); and
a fog generation unit (20) provided on top of the nozzle body (13) and comprising: a conical pneumatic chamber (22) filled with compressed air; and a secondary nozzle hole (26) spraying a fog,
wherein the secondary nozzle hole (26) is located directly above the primary nozzle hole (16) and arranged in a concentric manner with the primary nozzle hole (16),
wherein the fog includes a mixture of the compressed air and the liquid micro particles,
wherein the liquid micro particles sprayed from the primary nozzle hole (16) are provided to the secondary nozzle hole (26) via the conical pneumatic chamber (22),
wherein the liquid micro particles are secondarily broken down into the fog by a complex shearing force applied in the course of passing through the conical pneumatic chamber (22),
wherein the complex shearing force is created by the compressed air and applied to the liquid micro particles at a 360-degree angle from a circumference of the primary nozzle hole (16),
wherein an inlet (22a) is provided eccentrically on a side of the fog generation unit (20) and injects the compressed air into the conical pneumatic chamber (22) so that the compressed air swirls within the fog generation unit (20),
wherein the liquid micro particles are provided into the conical pneumatic chamber (22) via primary nozzle hole (16),
wherein the compressed air is provided into the conical pneumatic chamber (22) via the inlet (22a),
wherein the inlet (22a) is arranged perpendicular to the primary nozzle hole (16),
wherein the inlet (22a) is arranged eccentric to the primary nozzle hole (16) in the conical pneumatic chamber (22) so that the compressed air swirls in the conical pneumatic chamber (22) around the liquid micro particles,
wherein the compressed air injected into the conical pneumatic chamber (22) is directed toward an inclined exterior part (17) of the nozzle body (13),
wherein a tube extension part (16a) is provided at an external end of the primary nozzle hole (16) and is shaped to gradually expand toward the secondary nozzle hole (26),
wherein the liquid micro particles sprayed from the primary nozzle hole (16) are diffused toward the tube extension part (16a) and further broken down by a distending pressure in the tube extension part (16a).

2. The two-fluid fog generator of claim 1, further comprising:
a circular exterior part (18) protruded from the inclined exterior part (17); and
a low pressure flow portion (23) formed between the circular exterior part (18) and an inclined interior part (27), wherein the inclined exterior part (17) and the inclined interior part (27) face each other, wherein a bottom of the fog generation unit (20) forms the inclined interior part (27),
wherein a path, through which the compressed air passes, narrows down at the low pressure flow portion (23),
wherein, after passing through the low pressure flow portion (23), the compressed air is accelerated in a flow speed and creates the complex shearing force.
